(19) United States
(12) Patent Application Publication
(10) Pub. No.: US 2019/0063124 A1
(43) Pub. Date: Feb. 28, 2019

(54) LOCK FOR A REBATED DOOR

(71) Applicant: BONAITI SERRATURE S.P.A., Calolziocorte (IT)

(72) Inventor: Giovanni ASCHIERI, Torino (IT)

(21) Appl. No.: 16/081,716

(22) PCT Filed: Mar. 1, 2017
(86) PCT No.: PCT/EP2017/054794

§ 371 Date: Aug. 31, 2018

(30) Foreign Application Priority Data
Mar. 2, 2016 (IT) UB2016A001253

(51) Int. Cl. E05C 9/02; E05B 13/00; E05B 55/12; E05B 9/02; E05B 59/00; E05B 47/06

(52) U.S. Cl. CPC E05C 9/026; E05B 13/005; E05B 47/0696; E05B 9/02; E05B 59/00; E05B 55/12

(57) ABSTRACT

A lock for a door of the rebated type, comprises a containing box body, that is suitable for being housed in a cavity of the door, a latch that is movable between an extracted position and a retracted position in the box body and a driving device that is movable by means of a control handle, along an opening direction to move the latch from the extracted position to the retracted position. The driving device is movable, by a key-locking-member, along a locking direction opposite the opening direction, to reach a disengaged position in which the driving device is not engageable by the control handle so as to prevent driving of the latch. A bolt is provided that is movable, by means of the key-locking-member, from a non-operative position, in which it is retracted into the box body, to an operative position protruding outside the box body. The driving device comprises a locking arrangement shaped for locking the latch in the extracted position, preventing forced movement thereof from the outside to the retracted position, when the driving device is in the disengaged position in which is not engageable by the control handle.

### CROSS-REFERENCE TO RELATED APPLICATIONS

This application is a § 371 National Stage entry of PCT International Application No. PCT/EP2017/054794 filed Mar. 1, 2017. PCT/EP2017/054794 claims priority to Italian Application No. UB2016A001253 filed Mar. 2, 2016. The entire content of these applications is incorporated herein by reference.

### BACKGROUND OF THE INVENTION

The present invention relates to a lock for a door, in particular for a rebated door.

### PRIOR ART

Locks for a rebated door are known comprising a containing box body inside which a latch is fitted that is movable from an extracted position, with respect to the box body, to a retracted position in the box body. When the door is closed, with the rebate thereof next to the door jamb, the latch in the extracted position is received in a corresponding cavity obtained on the door jamb, this cavity being bounded by a retaining plate. By a handle that is drivable from the outside it is possible to act on the latch to transfer the latch from the extracted position to the retracted position, in this way making possible the opening of the door. The latch can be of mechanical or magnetic type.

Some locks, for security and privacy reasons or needs, not only close the door normally, but also have a locking function. In particular, a first type of lock has a security key-cylinder by means of which it is possible to lock the latch, preventing driving thereof by the handle. Such a lock, although it is provided with a key-locking function, has a limit represented by the fact that the security locking is performed by a sole element, in this case the latch. Thus, for example in the case of a break-in attempt by an ill-intentioned person, it is sufficient tamper only with the latch to bypass the locking with a key, or stress the door with a push that is more or less vigorous that releases the latch from the respective cavity of the door jamb.

A second type of lock on the other hand, in addition to the normal latch that cannot be locked in the extracted position, provides a bolt and an associated security-key cylinder, the latter being totally decoupled functionally and structurally from the latch. In other words, the security key cylinder acts only on the bolt.

In this type of lock, the key-locked condition is achieved only by the bolt engaged in the respective cavity of the door jamb. In key-locked-door conditions, i.e. with the respective bolt in the extracted position and received in the dedicated cavity of the door jamb, the latch is not locked in the extracted position, being held in this position only through the effect of the preloading stress of a spring inside the containing box body in the case of a mechanical latch, or by the action of magnetic attraction in the case of a magnetic latch. Thus the latch in itself does not constitute any problem in the event of a break-in attempt committable by an ill-intentioned person and the sole obstacle to overcome for the latter is represented by only the bolt. Also for this type of lock, in fact, the locked condition of the door relies on a sole element, in this case the bolt.

As hinted at, in this latter type of lock that has just been disclosed, the two parts of lock relating respectively to the latch and to the bolt are totally decoupled from one another both from the functional and structural point of view, which entails a significant general complexity with a high number of mechanical parts that are necessary for the relative operation thereof.

From DE3504125 a lock provided with a latch and bolt is known. The latch can be retracted into the box casing of the lock by a rotatable pushing member, which is drivable by a handle. The bolt is connected mechanically to a rear locking plate that is movable horizontally by a key cylinder. On the aforesaid rear locking plate a rotatable lever is hinged that returns the latch to the inner position. A substantially rectangular plate is provided that is guided by couplings of the pin-slot type, which transfers a movement of the key cylinder to the aforesaid rotatable lever, and a vertical stop plate, which is movable longitudinally, which in the lowered position, with the bolt extracted, locks the latch in the extracted position. A control plate is further provided, having the shape of an irregular pentagon, which connects the rear locking plate to the vertical stop plate to move the latter according to the movement of the bolt. It is clear that this lock includes a great number of mechanical components that define a driving mechanism that is structurally rather complex, accordingly expensive to make, the mechanical reliability of which, which as known decreases with the complexity and number of parts of a structure, is adversely affected thereby.

From CH671427 another lock is known also having a significant structural complexity and thus being affected by the same drawbacks set out above and by an unsatisfactory level of security provided.

CH446109 relates to another lock that does not however provide the levels of security and versatility that it is desired to obtain.

Another drawback of known locks is due to the fact that the accidental driving of the key cylinder to lock the door when the latter is not actually closed on the respective door jamb entails some problems; in particular, the outward projection of the bolt causes, by bringing up the door to the door jamb, damage to the door jamb, the more serious the greater the impetus with which the door is pushed to the closed position.

In the light of what has been said above, it would be desirable to dispose of a lock having improved features, that is structurally and functionally simplified and at the same time enables, with a key-locking modality, much higher levels of security to be reached than those currently provided by the known locks available.

### OBJECTS OF THE INVENTION

The object of the present invention is thus to provide a new and different solution for a lock for a rebated door, with a mechanical or magnetic latch, that responds to the aforesaid constructional and functional needs. In particular it is intended to:
a) provide greater levels of security in the key-locked condition of the door;
b) provide a constructionally simple lock, with a reduced number of mechanical components, which is thus extremely reliable;
c) provide the lock with features that permit a general improvement in operation and elimination of the drawbacks discussed above.

### SHORT DESCRIPTION OF THE INVENTION AND OF THE DRAWINGS

This invention aims to achieve the aforesaid objects and to overcome the drawbacks of conventional locks for a rebated, or hinged door.

The invention and some preferential embodiments thereof will be disclosed in greater detail below with reference to the drawings, in which:

FIGS. 1, 2 and 3 show three different operating conditions of a first lock embodiment according to the invention;

FIG. 4 is an exploded view of the first lock embodiment;

FIGS. 5 and 6 are two different views of a bolt of the first lock embodiment;

FIGS. 7 and 8 are two different views of a cursor element included in the first lock embodiment;

FIGS. 9, 10, 10A show a mechanical latch that can be provided in the various lock embodiments according to the invention;

FIGS. 11 and 12 show a magnetic latch that can be provided in the lock according to the invention alternatively to the aforesaid mechanical latch;

FIGS. 13, 14 and 15 show three different operating conditions of a second lock embodiment according to the invention;

FIGS. 16 and 17 are two different exploded views of the second lock embodiment;

FIGS. 18 and 19 are two different views of a bolt of the second lock embodiment;

FIGS. 20 and 21 are two different views of a cursor element included in the second lock embodiment;

FIGS. 22 and 23 show a further lock embodiment having a different geometry of cursor element and of latch corresponding to an alternative latch driving configuration.

### DETAILED DESCRIPTION OF THE INVENTION

A lock 1, 101 according to the invention is disclosed below that is suitable for being fitted, in particular, on an indoor door of the rebated type, i.e. a hinged door, but which can be applied in general in rotatable closing elements of the rebated type.

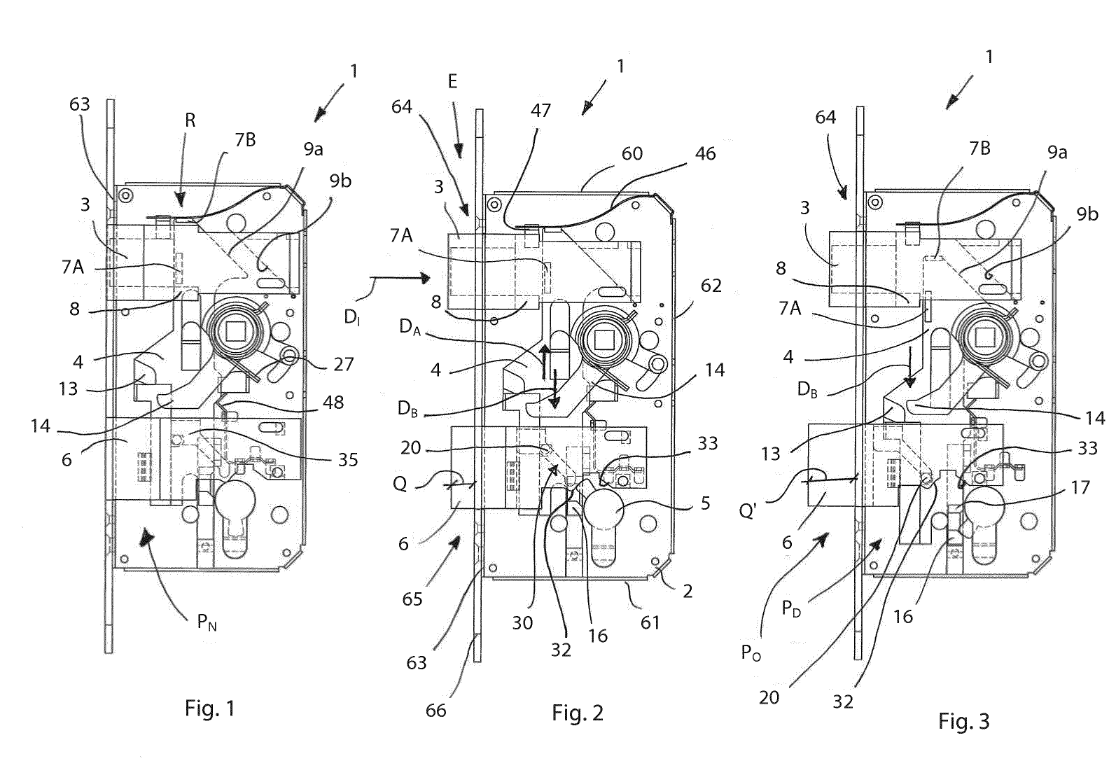

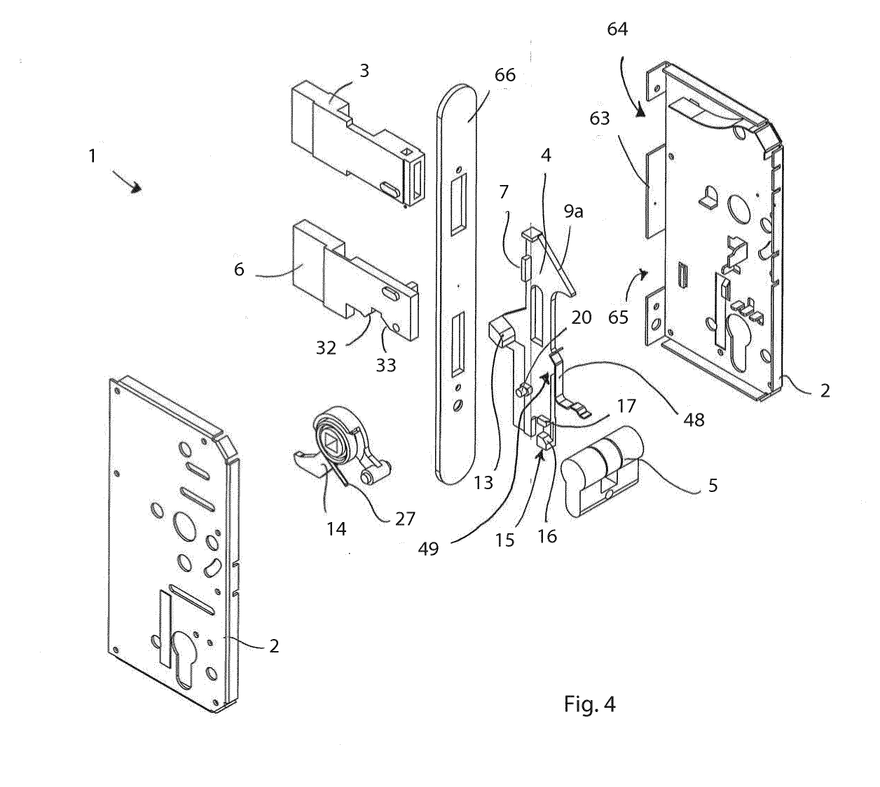

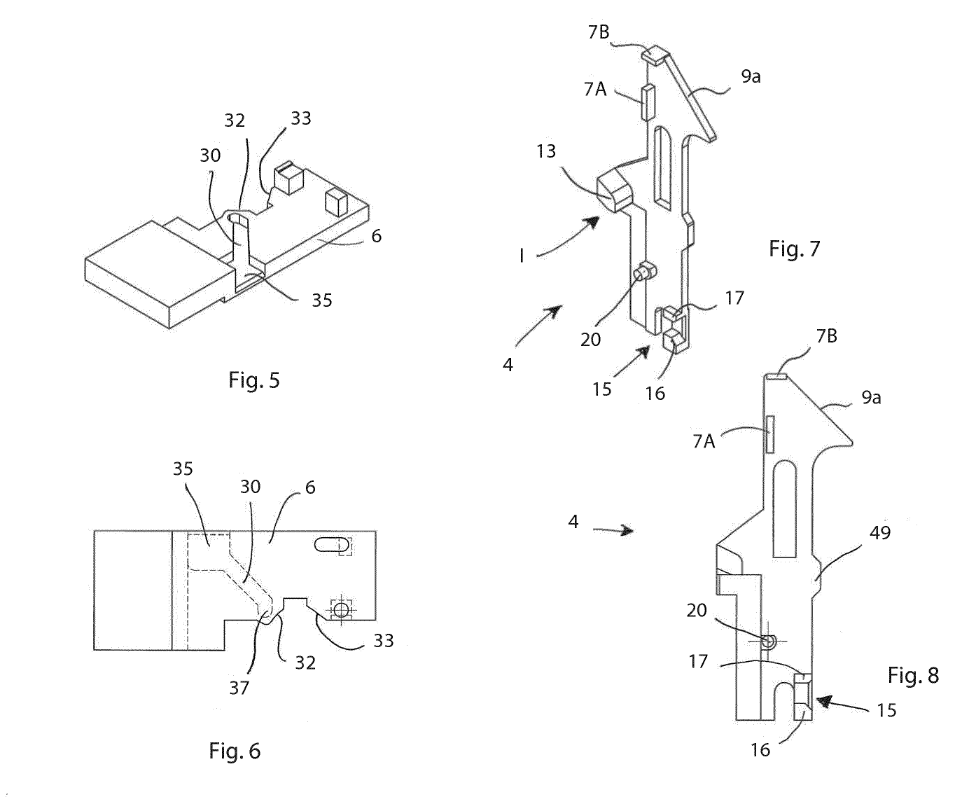

With reference to FIGS. 1 to 12, a first embodiment of the lock 1 is disclosed. The lock 1 comprises a containing box body 2, for example in pressed sheet steel, suitable for being housed in a cavity obtained in the door rebate. The containing box body 2 consists of two half shells that are mutually couplable to bound a chamber for the various components of the lock. The two half shells together define an upper wall 60, a lower wall 61, two lateral parallel walls, a rear wall 62, and a front wall 63 provided with respective upper 64 and lower 65 openings arranged for enabling a latch 3 and a bolt 6, which will be disclosed below, to exit.

A frontal closing plate 66 is provided that, once inserted the box body 2 inside the cavity of the door, is applied to the front wall 63 fixed by the same screws that fix the lock 1 to the door.

The lock 1 comprises a latch 3 or 3′ that is movable, along an entrance direction D_{I}, between an extracted position E, i.e. protruding outside the box body 2, and a retracted position R in which the latch 3 is positioned inside the box body 2.

The latch 3 or 3′ is suitable for engaging a retaining plate that is mounted on the door jamb at the engaging cavities for latch and bolt.

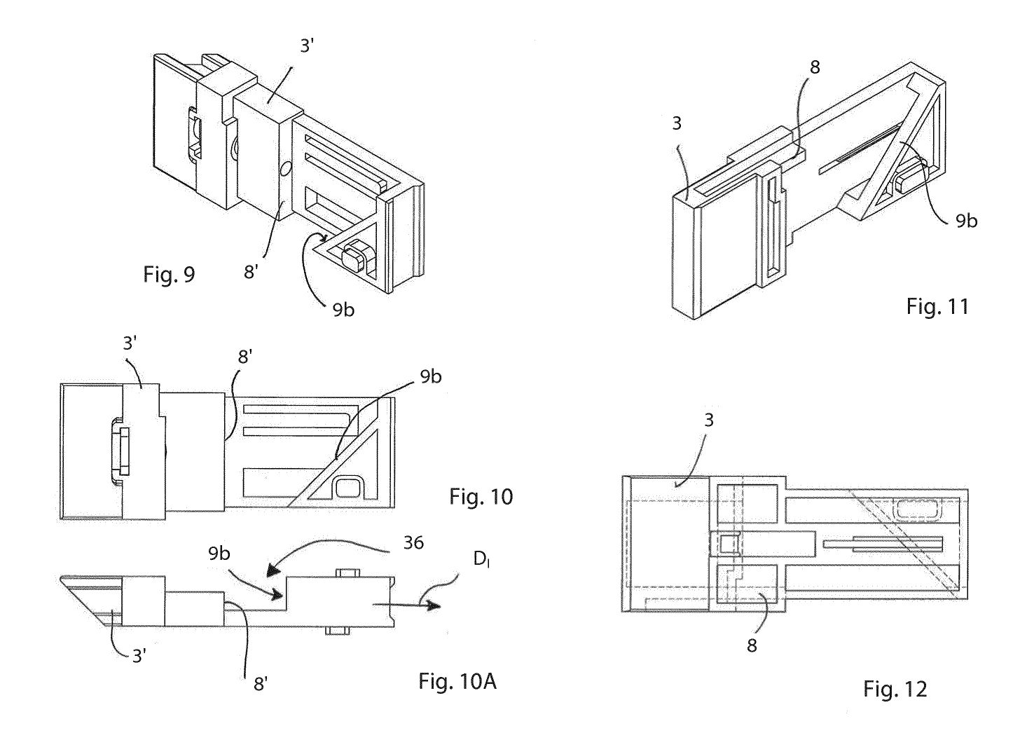

For the sake of simplicity, (in FIGS. 1 to 4) only the lock embodiment 1 with magnetic latch 3 is shown, the embodiment with mechanical latch 3′ (shown in FIGS. 9, 10, 10A) being functionally and structurally identical apart from details that will be made clear below.

The lock comprises a driving device 4 that is movable along an opening direction D_{A} to move the latch 3 from the extracted position E to the retracted position R. The driving device 4 is movable along the aforesaid opening direction D_{A} by a rotatable lever member 14 that is in turn drivable by an outer control handle.

In particular, the opening direction D_{A} is transverse to the entrance direction D_{I} along which the latch 3 is movable.

To move the latch 3 from the extracted position E to the retracted position R, the lock 1 is provided with a motion transferring arrangement (9a, 9b; 10a, 10b, 11), disclosed better below, which transforms a movement of the driving device 4 along the opening direction D_{A} into a movement of the latch 2 in the entrance direction D_{I}.

The driving device 4 is moreover movable by a key-locking-member 5, along a locking direction D₈ opposite the aforesaid opening direction D_{A}, to reach a disengaged position P_{D} in which the driving device 4 is disconnected and not engageable by the lever member 14 coupled with the outer control handle. In this manner, driving of the latch 3 is prevented. This disengaged position P_{D} is visible in FIG. 2. Basically, when the driving device 4 is in the disengaged position P_{D}, possible driving of the outer handle does not have any effect on the driving device 4. In other words, the handle is in a “idle” configuration, and does not influence the position of the latch 3 at all. The driving device 4 is held elastically in an intermediate position, which is engageable by the handle, by a flexure spring 46 that rests on a fixed shelf wing 47 of the containing body. When the driving device 4 is raised along the opening direction, a top portion thereof meets a resistance of the flexure spring 46 that returns the driving device 4 to the rest position as soon as the outer handle is released.

The driving device, in particular, comprises a cursor element 4 that will be disclosed in detail below.

The lock 1 comprises a bolt 6 for locking by key the door. The bolt 6, which is drivable by the aforesaid key-locking-member 5, is movable from a non-operative position P_{N}, in which it is retracted into the box body 2, to an operative position P_{O} in which it protrudes outside the box body 2. The key-locking-member 5 in particular comprises a key cylinder provided with a bit element, that is rotatably drivable by inserting a suitable key. In another embodiment, the key-locking-member 5 is defined, instead of by a key cylinder, by a suitable key provided with a stem and a suitably shaped driving portion.

The aforesaid motion transferring arrangement (9a, 9b; 10a, 10b, 11) is now disclosed, which comprises part of the cursor element 4, and part of the latch 3 (or 3′, 3″).

Specifically, the motion transferring arrangement comprises a pushing-portion 9a obtained on an upper zone of the cursor element 4, and a follower-portion 9b obtained on the latch 3 (3′). The pushing-portion 9a is shaped for coming into contact with the follower-portion 9b to push the latch 3 (or 3′) into the retracted position R when the cursor element 4 advances along the opening direction D_{A}. The pushing-portion 9a and the follower-portion 9b are then shaped to slide on one another in reciprocal contact.

In the lock embodiment 1 shown in FIGS. 1 to 12, in particular, the pushing-portion of the cursor element 4 and the follower-portion of the latch 3 (or 3′) comprise respectively a tilted surface 9a, and a further tilted surface 9b arranged transversely to the entrance direction D_{I} and to the opening direction D_{A}. In other words, the motion transferring arrangement, in the disclosed embodiment, is configured for establishing between the cursor element 4 and the latch 3 a sliding according to a plane that has a tilted lying position with respect to the opening direction D_{A} and to the entrance direction D_{I}.

In one embodiment (not shown), it is possible to provide, in replacement of just one of the two tilted surfaces 9a and 9b, a wheel portion, or another equivalent solution, which is able to slide on the remaining tilted surface. This possible configuration can also be applied to the lock embodiment 101 that will be disclosed further on.

Still with reference to FIGS. 1 to 12, the cursor element 4 comprises an engaging lug 13, placed in an intermediate zone 1 of the cursor element 4 (FIG. 7), and suitable for coupling with the lever member 14 that is drivable by the outer handle. When the lever member 14 couples with the engaging lug 13, the cursor element 4 can be advanced along the opening direction D_{A}. Basically, a nose portion of the lever member 14 acts on a lower zone of the engaging lug 13 by pushing upwards the cursor element 4 that can in this way retract the latch 3 (or 3′) into the containing box body 2. The lever member 14 is urged elastically to a rest position by a suitable torsion spring 27.

The cursor element 4 comprises an abutting zone 15, opposite the pushing-portion 9a, suitable for interacting with the key-locking cylinder 5.

The abutting zone 15 comprises a first abutting portion 16 that is suitable for receiving from the key-locking cylinder 5 a pushing action for the cursor element in the locking direction D_{B}, thus in particular downwards.

The abutting zone 15 comprises a second abutting portion 17 that is suitable for receiving from the key-locking cylinder 5 a further pushing action to move the cursor element 4 in the opening direction D_{A}, thus in particular upwards. The first abutting portion 16 and the second abutting portion 17 project orthogonally to the plane defined by the cursor element 4, in other words parallel to the rotation axis of the key-locking cylinder 5.

The cursor element 4 is further provided with a pin protrusion 20, shaped for engaging with a driving groove 30 obtained on the bolt 6.

The groove 30 comprises a tilted portion in such a manner that a movement of the cursor element 4 in the locking direction D_{B} causes the bolt 6 to protrude to the outside of a length Q. On the other hand, a movement of the cursor element 4 in the opening direction D_{A} is matched by a retracting movement of the bolt 6 to inside the box body 2. A widened zone 35 of the groove 30, placed in a more advanced position, i.e. nearer the front wall 63, disengages the bolt 6 from the pin protrusion 20, enabling it to move by a certain amount equal to half the total length of extracting to the outside. The groove 30 further comprises a locking portion 37, extending orthogonally to the movement direction of the bolt 6. In particular, the locking portion 37, with reference to FIG. 6, extends vertically. The pin protrusion 20, when it is positioned in the aforesaid locking portion 37, acts as a locking arrangement 20 for locking the bolt 6 in the extracted operative position P_{O}, preventing forced movements thereof from the outside.

The bolt 6, which is housed in a zone approximately comprised between the engaging lug 13 and the abutting zone 15 of the cursor element 4, comprises an extracting abutment 32 shaped for coming into contact with, and receiving a pushing action from the key-locking-member 5. The push of the key-locking-member 5 on the extracting abutment 32 causes the bolt 6 to exit from the box body 2 by a first amount Q. The lowering of the cursor element 4, by the locking member 5, causes the bolt 6 to advance further outside by a further amount—that can be the same as, or different from, the aforesaid amount Q—until the maximum protruding end position is reached, i.e. the operative position Po shown in FIG. 3. This is made possible owing to the lowering of the pin protrusion 20—along the locking direction D_{B}—that forces the driving groove 30 to “follow” it, in this manner causing the movement of the bolt 6 to the operative position P_{O}. Thus in the maximum protrusion position the bolt 6 protrudes by an amount Q′. In particular, but not in a limiting manner, the maximum protrusion length (i.e. the amount Q′) is 20 mm.

In this operative position P_{O}, the bolt 6 protrudes by 20 mm, or another desired amount, with respect to the containing box body 2.

The bolt 6 comprises a return-abutment 33, in a position that is retracted with respect to the extracting abutment 32. The return-abutment 33 is shaped for coming into contact with, and receiving a pushing action from the bit of the key-locking cylinder 5, to return the bolt 6 to inside the box body 2.

The cursor element 4 comprises a locking arrangement (7A or 7B) shaped for locking the latch (3 or 3′) in the extracted position E, preventing forced movement thereof from the outside to the retracted position R, when the cursor element 4 is in the disengaged position P_{D}, disconnected from the lever 14 member. In other words, the locking arrangement (7A or 7B) intervenes to prevent the latch retracting, by an undesired outer action, when the lock 1 is in the key-locking configuration. Thus in the key-locking configuration not only does the possible rotation of the idle handle not have any effect on the latch 3, but any forced movement of the latch is also prevented.

In the lock embodiments I with magnetic latch 3, the locking arrangement comprises a locking ridge 7A shaped for restingly receiving a protruding wall 8 of the latch 3. In particular, the locking ridge comprises a locking wing 7A that projects orthogonally near an edge of the cursor element 4 facing the front wall 63 of the box body 2. In the locked condition with the cursor element 4 in a lowered position in which also the bolt 6 is in a position protruding outside, movement of the latch 3 from the extracted position E to the retracted position R is prevented. It is obvious that in this condition, the zones that are actually locked in the extracted position ensuring locking in total security of the door are two, unlike what occurs with the prior art systems disclosed previously. Further, the protruding wall 8 provided on the magnetic latch 3 has a further function. In conditions with the open door, the magnetic latch 3 is in a non-operating condition, i.e. is freely housed inside the containing box body 2. In this condition, the cursor element 4, by acting by means of the key-locking cylinder 5, is prevented from descending along the locking direction D_{B}; this effect is achieved through the protruding wall 8 which, in the retracted position R of the latch 3, is placed immediately below the locking wing 7A, impeding the movement thereof downwards. The advantageous effect of this configuration is to prevent the exit of the bolt 6 from the box body 2 when the door is not actually drawn against the respective door jamb, thus preventing the latter from being damaged if the door is pushed against the door jamb with the bolt in a protruding position.

The protruding wall 8 enables the cursor element 4 to be moved in the locking direction D_{B} only when the magnetic latch 3, attracted magnetically into the extracted position E, is thus received correctly into the respective cavity of the door jamb.

With respect to the embodiment that has just been disclosed with magnetic latch, the lock 1 that is provided with a mechanical latch 3′ has small differences in terms of the locking arrangement. Substantially, the locking arrangement comprises, instead of the locking wing 7A (which is absent in this case), a different locking ridge, i.e. a turret portion 7B obtained on the summit of the cursor element 4, which also has the function of interacting with the flexure spring 46 that urges the cursor element 4 downwards. The turret portion 7B is shaped for restingly receiving, and locking, a further protruding wall 8′ placed on the mechanical latch 3′.

When the cursor element 4 is in the lowered position, i.e. in the locked condition by key of the lock 1, the turret portion 7B is below the shelf wing 47 on which the flexure spring 46 rests. In particular, the turret portion 7B, being housed in a recess zone 36 of the latch 3′ (FIG. 10A), is at the protruding wall 8′ that is then stopped in the retracting movement to the inside of the containing box body 2 along the entrance direction D_{I}.

In all the lock embodiments according to the invention, both in the embodiments that have just been described, and in those described below, the locking arrangement 7A, or 7B, are obtained integrally on the cursor element, i.e. they are made as a single piece with the cursor element. In other words, the locking arrangement is part of the cursor element. The locking function of the latch, which is thus assigned to a part of the cursor element, is accordingly performed by an element that is distinct from the bolt, unlike some prior-art locks in which the locking function of the latch is on the other hand assigned to the bolt when the latter reaches the extracted position. The fact that the locking function of the latch is performed by the cursor element, which is totally contained in the box body (2; 102) and thus, not being accessible, is immune to break-in attempts, makes the level of security and resistance to break-ins provided by the present lock much higher than with the type of known lock that has just been mentioned: in the latter case it is possible to act directly on the bolt in an extracted, and thus accessible, position, to tamper with the locking function and thus force the lock, this not on the other hand being possible with the lock according to this invention.

The operation of the lock 1 of this invention is now disclosed concisely.

When the door is open, the lock 1 is in the condition shown in FIG. 1, i.e. with the bolt 6 in the non-operative position P_{N} and with the magnetic latch 3 in the retracted position R, thus freely retracted to inside the containing box body 2. Obviously, in the case of a lock 1 with a mechanical latch 3′, the latter, in the rest position, is in a position protruding from the containing box body 2, urged by a suitable inner spring. In this condition, possible driving of the cylinder 5 for key-locking of the lock 1 is prevented by the protruding wall 8 of the latch that obstructs the movement to the locking ridge 7A in the locking direction D_{B}.

Once the door has been closed against the door jamb, the magnetic latch 3 is attracted magnetically, for example through the effect of a magnetic element associated with the door jamb, to inside the respective cavity provided on the door jamb. In this manner the protruding wall 8 disengages from the locking ridge 7A, which is thus free to proceed downwards. By starting the rotation of the cylinder 5—anticlockwise with respect to FIGS. 1 to 3—the bit element of the cylinder 5 comes into contact with the extracting abutment 32, pushing the extracting abutment 32 outside for a first length Q. During this first extracting step, the pin protrusion 20 of the cursor element 4 does not hinder the movement of the bolt 6, owing to the widened zone 35 of the groove 30 disclosed previously.

By continuing the rotation of the cylinder 5, the bit element moves away from the extracting abutment 32 and comes into contact with the first abutting portion 16 of the cursor element 4. The bit element 5 then pushes the abutting portion 16 downwards, in the locking direction D_{B}, thus taking the cursor element 4 to the disengaged position P_{D} in which it is disconnected from the lever 14 coupled with the outer handle. During the lowering of the cursor element 4, the pin protrusion 20 abandons the widened zone 35 and penetrates the narrowest portion of the groove 30 forcing, with a movement descending along the driving groove 30, the bolt 6 to exit by a further amount Q. In this configuration, the cursor element 4 is lowered into the locking position and the locking ridge 7A, i.e. the locking wing 7A, is in a position that is such as to lock the protruding wall 8. In this key-locked condition of the lock 1, any attempt from outside to push the latch 3 (or 3′) to the inside is prevented. The pin protrusion 20, engaged in the locking portion 37 of the groove 30, blocks in the extracted position the bolt 6, preventing any movement thereof caused by possible forcing from outside.

Two elements of the lock are thus locked, i.e. latch and bolt, significantly improving the achievable levels of security. The lock 1 thus permits key-locking and bolt-locking owing to a complete rotation of the cylinder 5.

It should be noted that the bit element of the cylinder 5, in the condition shown in FIG. 3, points, from above, against the first abutting portion 16 that is therefore locked in this position, thwarting possible forcing from the outside aiming to raise the cursor element and make the bolt 6 retract.

To open, the opposite procedure is followed. Thus by rotating the cylinder 5 clockwise this time, the second abutting portion 17 is pushed upwards: the pin protrusion 21 of the cursor element 4, moving upwards, forces the bolt 6 to retract, by half a stroke, into the box body 2. By continuing the clockwise rotation of the cylinder 5, the bit element engages the return-abutment 33, which is pushed in the entrance direction D_{I}, making the bolt 6 retract to inside the box body 2.

The cursor element 4 is pushed further upwards, thus beyond the normal rest position, and by contrasting the first flexure spring 46 can also perform the function normally assigned to the handle, i.e. it is able to retract the latch in the containing box body 2 and enable the door to be opened. This is possible owing to the abutting portion 16—obtained on the cursor element 4—which can receive a downward push directly from the bit element of the member 5.

A second flexure spring 48 is provided that by interacting with a cam profile 49 of the cursor element 4, establishes a rest position for the cursor element 4, and supplies a pleasant tactile feedback to the user during driving of the cylinder 5. This tactile feedback signals that a complete opening and closing manoeuvre of the lock 1 has been achieved, giving the user the sensation of performing the various door-locking and unlocking tasks completely and correctly.

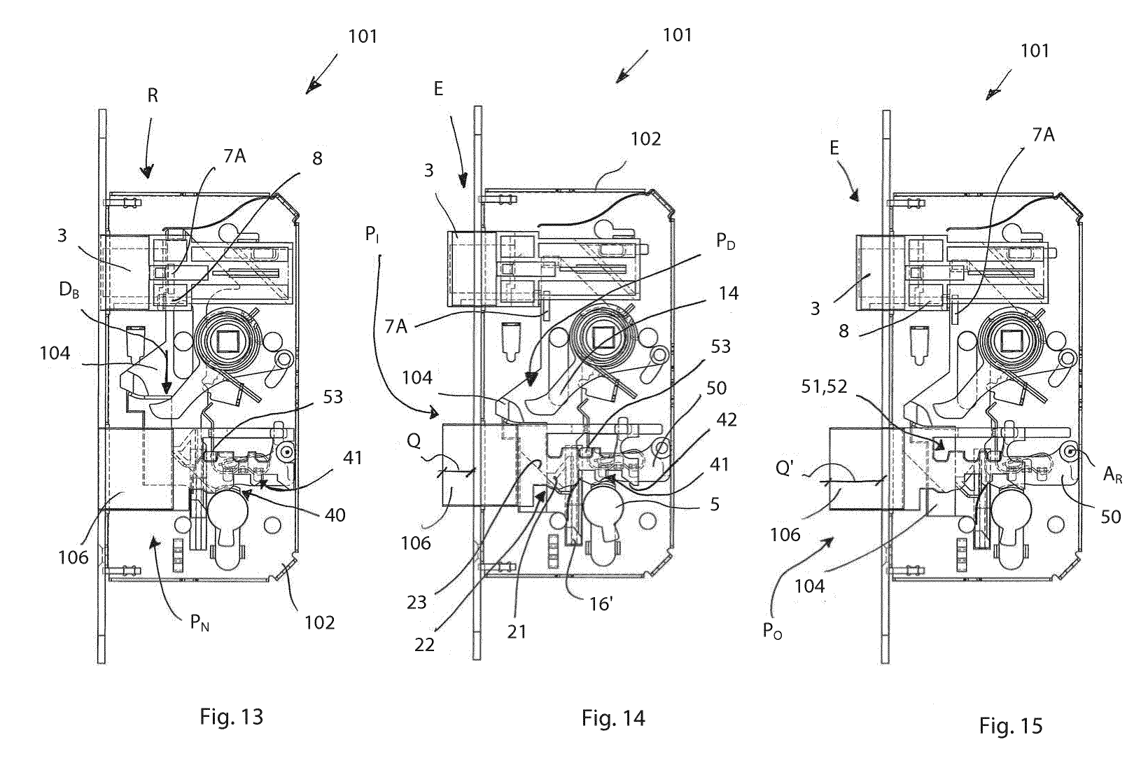

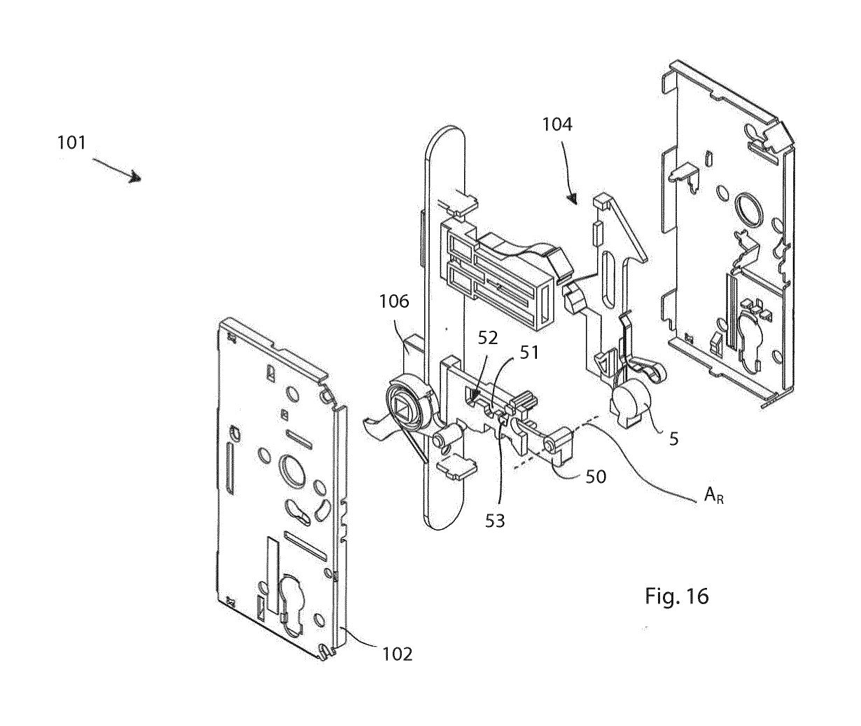

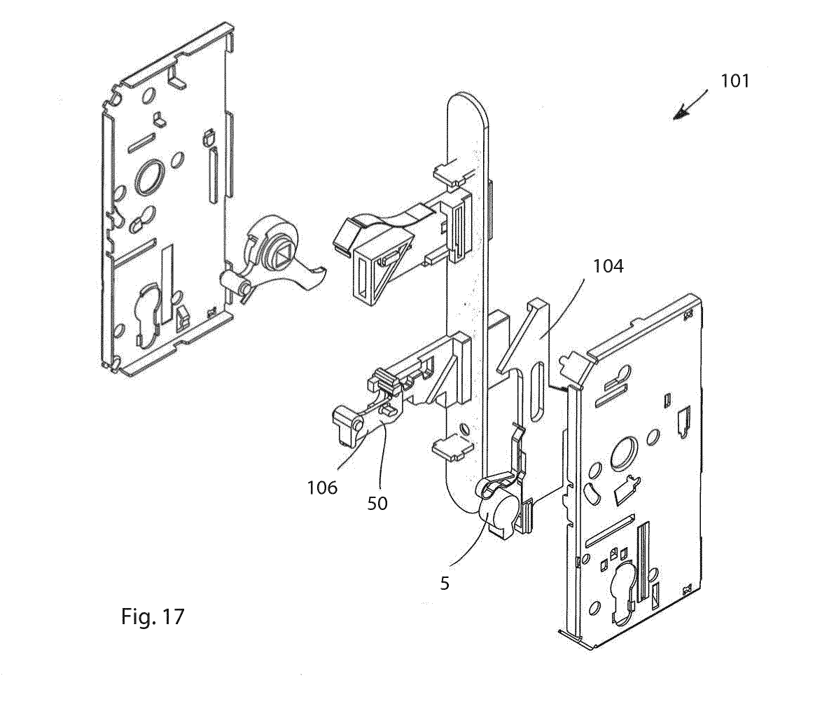

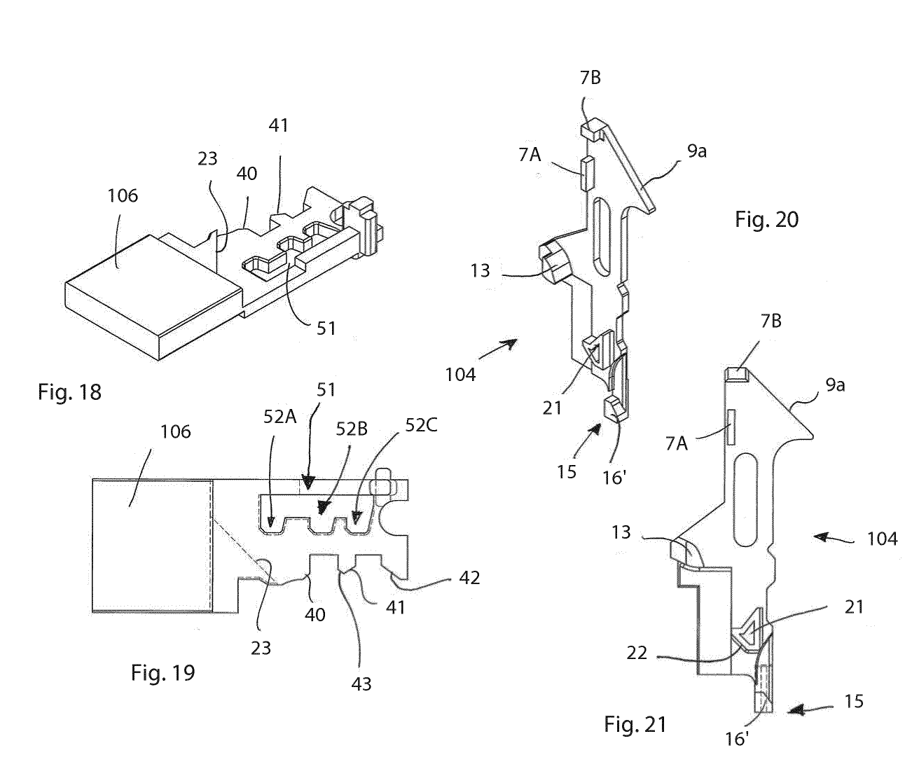

FIGS. 13 to 16 show a second lock embodiment 101, which has many parts in common with the first disclosed embodiment, and which thus for the sake of simplicity are left out. The differences from the lock embodiment disclosed previously relate to the cursor element 104 and to the bolt 106. Substantially, as will be clear from the following description, in the lock 101, the key-locking cylinder 5 pushes directly, in two consecutive steps, the bolt 106 to the outside operative position P_{O}.

In fact, the bolt 106 comprises a first extracting abutment 40, shaped for receiving from the cylinder 5, at a first rotation of the latter, a first pushing action causing the exit of the bolt 106 from the box body 102 by a first amount Q.

The bolt 106 comprises a second extracting abutment 41, obtained in the position that is more retracted than the first extracting abutment 40 and shaped for receiving from the cylinder 5, at a second rotation of the latter, a second pushing action causing the exit of the bolt 106 from the box body 102 by a second amount, which can be the same as or greater than or less than the preceding quantity Q. In the maximum protruding position, the bolt 106 thus protrudes by an amount Q′ that can be, for example, but not in a limiting manner, equal to 22 mm.

The bolt 106 comprises a first return abutment 42, obtained in a rear zone, shaped for receiving from the key-locking cylinder 5 a first push for retracting the bolt 106 by a first amount to inside the box body 102.

The bolt 106 comprises a second return abutment 43, in a more advanced position than the first return abutment 42, and shaped for receiving from the cylinder 5 a second push for completing the retracting movement of the bolt 106 into the box body 102. The bolt 106 further comprises a wall bounded by a mover tilted surface 23 suitable for interacting with a follower tilted surface 22 provided on the cursor element 104, as disclosed better below.

The lock 101 is provided with a further locking arrangement 50, shaped for blocking the bolt 106 in the extracted operative position P_{O}, preventing forced movement thereof from the outside to the inside of the containing box body 102. In particular, the further locking arrangement 50 locks the bolt 106 also in further positions, such as an intermediate protruding position P_{I}, and the non-operative position P_{N} inside the box body 102.

The further locking arrangement 50 comprises a pawl member 50, which is rotatable around a rotation axis A_{R}, and configured for locking the bolt 106 in various positions preventing forced movements thereof from the outside. The pawl member 50 is drivable by the bit element of the key-locking-member 5 that lifts the pawl member 50 upwards to transfer the pawl member 50 from a locked configuration—in which it locks any movement of the bolt 106—to a release configuration that permits the translation exit or entrance of the bolt 106. On the bolt, a locking groove 51 is obtained having a toothed profile with three distributed recess zones 52, shaped for coupling with a tooth 53 of the aforesaid pawl member 50. With reference to FIGS. 13, 14, 15, and 19, the receipt of the tooth 53 in the front recess zone 52a locks the bolt 106 in the non-operative position P_{N}, shown in FIG. 13. When the tooth 53 couples with the intermediate recess zone 52b, the bolt 106 is locked in the intermediate protruding position P_{I}, shown in FIG. 14. When the tooth 53 is received in the rear recess zone 52c it locks the bolt 106 in the operative position P_{O}, shown in FIG. 15.

The cursor element 104 is now disclosed that differs from the embodiment disclosed previously through a different geometrical configuration of the abutting zone 15 and of the protrusion element 21.

The cursor element 104 comprises an abutting portion 16′ that is suitable for receiving from the key-locking-member 5 a pushing action by which the cursor element 104 is moved in the locking direction D_{B}. In this case an upper abutting portion is missing that is on the other hand present in the cursor element 4 of the preceding embodiment.

The protrusion element 21 in this case comprise a protrusion with a polygon-shaped section. The protrusion 21 comprises a follower tilted surface 22, which has already been mentioned previously, which is shaped for slidingly engaging with the mover tilted surface 23 obtained on the bolt 106. The mover 23 and follower 22 tilted surfaces are shaped so as to impose on the cursor element 104 an upward movement in the opening direction D_{A} when the bolt 106 is returned to inside the box body 102. Thus unlike the lock 1, in the lock 101 it is the bolt 106, which is in turn pulled by the cylinder 5, which pushes upwards the cursor element 104 during the step of unlocking and opening the lock 101.

For the locking function performed by the protruding wall 8 and by the locking ridge 7A, what was disclosed previously for the first lock embodiment 1 applies similarly.

The operation of the lock 101 is now disclosed briefly, omitting the description of parts that, being very similar both functionally and structurally to the lock embodiment 1, have already been disclosed previously.

Starting from the open condition shown in FIG. 13, once the door has been taken to the door jamb of the wall, the latch 3 is attracted to the extracted position E, as shown in FIG. 14.

The protruding wall 8 thus leaves the locking ridge 7A freedom of movement downwards. By starting rotation of the cylinder 5 (anticlockwise in FIGS. 13 to 15) the bit element of the cylinder 5 first lifts the pawl member 50, acting on a lower profile thereof, disengaging the tooth 53 from the front recess 52a of the locking groove 51 (FIG. 19). The bit element of the cylinder 5, whilst it maintains the pawl member 50 in the raised release position, comes into contact with the first extracting abutment 40 to push the latter. At this point the bolt 106 starts to be transferred from the non-operative position P_{N} of FIG. 12 to the intermediate protruding position P_{I} of FIG. 14. In the intermediate protruding position P_{I}, the tooth 53 is again in the locked position, this time coupled with the intermediate recess 52b. The bit element of the cylinder 5 subsequently interacts with the abutting portion 16′, pushing the abutting portion 16′ in the locking direction D_{B}. At this point, the cursor element 106 is lowered into the disengaged position P_{D} and the latch 3 is locked, by the ridge 7A, in the extracted position E, as shown in FIG. 14. Thus, in this condition in which the bolt 106 protrudes by a first amount Q, the cylinder 5 has made a complete rotation, i.e. a first turn. By continuing the anticlockwise rotation, the cylinder 5 engages the second extracting abutment 41, after raising the pawl member 50 to disengage the pawl member 50 from the intermediate recess 52b. The bolt 106 is thus pushed outside by a second amount Q, as far as the operative position P_{O} of maximum protrusion. In this position, the tooth 53 engages the rear recess 52c, locking the bolt 106. This locked condition of the lock 101 is thus reached with two complete rotations of the key-locking cylinder 5, i.e. with two turns of the key, unlike the lock 1 in which this condition is reached with just one complete rotation of the cylinder 5.

Both the latch 3 (or 3′) and the bolt 106 are thus blocked in the protruding position.

To open, the reverse procedure is followed. By rotating the bit element of the cylinder 5 this time clockwise, first the first return abutment 42 is engaged, with simultaneous lifting of the pawl member 50. The bolt 106 is thus retracted within a half stroke. At a subsequent rotation, the bit element 5 engages the second return abutment 43, to push the bolt 106 by a further half stroke to inside the containing box body 102. During this subsequent return movement of the bolt 106, the mover tilted surface 23, after coming into contact with the follower tilted surface 22 of the cursor element 104, pushes the latter upwards, returning the cursor element 104 to the rest condition in which it is engageable by the lever member 14 that is drivable by the handle. Upon completion of two rotations of the cylinder 5, the bolt 106 has reached the retracted non-operative position P_{N}. Also in this case, by possibly continuing to rotate the cylinder 5 clockwise, the bit element can come into contact with, and lift the abutting portion 16′ to retract the latch 3, thus also performing the function normally performed by the outer handle.

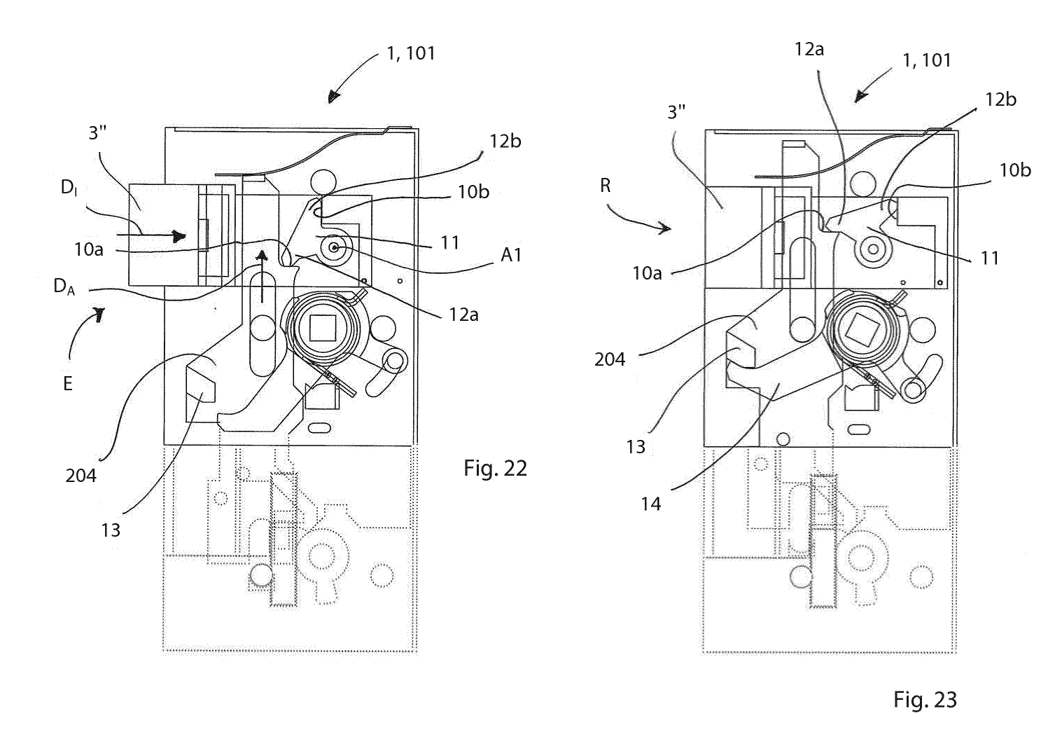

FIGS. 22 and 23 show a further possible configuration of a motion transferring arrangement that is alternative to the previously disclosed embodiments both in terms of lock 1 and of lock 101. This configuration provides a partial modification of the cursor element, which is indicated by 204, and of the latch, which is indicated by 3″, which can in turn be magnetic or mechanical.

According to this configuration, the motion transferring arrangement comprises a pushing-portion 10a obtained on the cursor element 204, a follower-portion 10b obtained on the latch 3″, and a rotatable lever member 11 interposed between the aforesaid portions 10a and 10b.

The pushing-portion 10a and the follower-portion 10b in particular comprise respective surfaces that are arranged according to horizontal planes orthogonally to one another. In particular, the pushing-portion 10a comprises a surface arranged substantially orthogonally to the opening direction D_{A} in which the cursor element 204 is movable, whilst the follower-portion 10b comprises a surface arranged substantially orthogonally to the entrance direction D_{I} in which the latch 3″ is movable. The lever member 11 is rotatable around an axis A1 that is orthogonal to the plane defined by the aforesaid opening direction D_{A} and entrance direction D_{I} and comprises appendages 12a and 12b suitable for engaging respectively the pushing-portion 10a and the follower-portion 10b. The appendage 12a receives the push from the cursor element 204 whilst the appendage 12b transfers the push to the follower-portion 10b: in this manner a movement of the cursor element 204 along the opening direction D_{A} is transformed into a movement of the latch 3″ along the entrance direction D_{I}.

All the embodiments disclosed above provide a cursor element that is movable linearly along a rectilinear trajectory. More precisely, the cursor element is movable linearly in the locking direction D_{B} and in the opening direction D_{A} orthogonally to the entrance direction D_{I} of the latch.

From what has been disclosed and shown in the drawings it is clear that the lock 1, 101 according to the invention enables the declared objects to be achieved. In particular, a new lock solution for a rebated door is provided, with a mechanical or magnetic latch, which ensures greater levels of security in the key locked condition of the door. The disclosed lock according to the invention is constructionally simpler, with a reduced number of mechanical components, thus much more reliable than prior-art locks with bolts, in which the two lock parts relating respectively to the latch and to the bolt are totally decoupled from one another, both from the functional and structural point of view, with consequent great general complexity and a great number of mechanical parts.

In particular, the lock according to the invention is equipped with the cursor element (4; 104; 204) which is able to perform many functions.

In other words, a sole mechanical driving element, i.e. the cursor element (4 or 104 or 204), is able to:
interact directly, without the need for other interposed components, with the lever 14 (controlled by an external handle) in order to drive the latch to open the door,
interact directly, without interposed elements, with the key-locking-member 5 to reach the disengaged position P_{D} in which it is disconnected from the lever 14 and makes the movement of the handle idle, neutral, i.e., devoid of effect on the latch,
perform, when it is in the disengaged position P_{D}, the security locking function for the latch owing to the locking ridge (7A, or 7B) obtained directly thereupon, i.e. made as one piece with the cursor element, this locking ridge (7A, or 7B) opposing the latch directly, i.e. without the need for other interposed elements.

Further, when it is desired to open the door, with a suitable rotation of the key-locking-member 5, the cursor element (owing to the presence of the abutting portion 16 or 16′ obtained wholly thereupon) is drivable directly, without interposed elements, by the member 5 so as to retract inside the latch without necessarily acting on the handle, with the advantage of greater versatility of the lock. In other words, the cursor element is geometrically configured so as to be able to connect operationally directly the key-locking-member 5 with the latch in the door opening operation. The result is clearly a great structural simplification of the lock.

The significant structural simplification, together with the particular configuration of the cursor element provided with the locking arrangement for the latch, and the significant length of protrusion of the extracted bolt (double extraction) enable high levels of security to be obtained for the lock that have never been reached by known locks.

What has been said and shown in the attached drawings has been provided to illustrate the innovative features of the lock 1, 101 for a rebated door according to two possible embodiments.

Modifications can be made to the lock or to parts thereof without thereby falling outside the scope of the claims.

In practice, the materials, inasmuch as they are compatible with the specific use and with the respective single components for which they are intended, can be chosen opportunely according to the required requisites and according to the available prior art.

It is moreover possible to configure and dimension the lock and adopt materials according to need and possible variations on and/or additions to what has been disclosed and illustrated in the attached drawings are possible.

1-22. (canceled)

22. Lock for a door of the rebated type, comprising
a containing box body, suitable for being housed in a cavity of said rebated door;
a latch that is movable, along an entrance direction, between an extracted position and a retracted position in said box body;
a driving device movable, by means of a control handle, along an opening direction, which is transverse to said entrance direction, to move said latch from said extracted position to said retracted position,
said driving device being movable, by a key-locking-member, along a locking direction opposite said opening direction, to reach a disengaged position in which said driving device is not engageable by said control handle thus preventing the driving of said latch,
a bolt that is drivable by said key-locking-member to move from a non-operative position, in which it is retracted into said box body, to an operative position protruding outside said box body,
wherein said driving device is defined by a cursor element on which are obtained:
a pushing-portion shaped for moving said latch to said retracted position when said cursor element advances along said opening direction,
an engaging lug, placed in an intermediate zone of said cursor element, arranged for coupling with a lever that is drivable by said control handle to move said cursor element along said opening direction,
an abutting zone, obtained at an end which is opposite with respect to said pushing-portion, and shaped for interacting with said key-locking-member of said lock, said abutting zone having a portion shaped for receiving from said key-locking-member a pushing action to move said cursor element along said locking direction to said disengaged position in which it is disengaged from said lever
and wherein on said cursor element a locking arrangement is obtained shaped for locking said latch in said extracted position, preventing forced movement thereof from the outside to said retracted position, when said cursor element is in said disengaged position in which it is disengaged from said control handle.

23. Lock according to claim 22, further comprising a further locking arrangement shaped for locking said bolt in said operative position, preventing forced movement thereof from the outside to the inside of said containing box body.

24. Lock according to claim 22, wherein said locking arrangement comprises a stopping ridge shaped for restingly receiving a protruding wall of said latch preventing a movement of said latch from said extracted position to said retracted position when said driving device is in said disengaged position, and said bolt is in a position protruding from said box body.

25. Lock according to claim 22, wherein said latch, of magnetic type or of mechanical type, is movable from said extracted position to said retracted position along an entrance direction that is orthogonal to said opening direction, a motion transferring arrangement being provided that is configured to impose on said latch a movement along said entrance direction corresponding to a movement of said driving device along said opening direction.

26. Lock according to claim 22, wherein said bolt is housed between said intermediate zone and said abutting zone, and said cursor element is provided with a protrusion element that is suitable for engaging with said bolt.

27. Lock according to claim 25, wherein said motion transferring arrangement comprises said pushing-portion, provided on said cursor element, and a follower-portion obtained on said latch.

28. Lock according to claim 27, wherein said pushing-portion and said follower-portion are shaped for coming into reciprocal contact to slide on one another.

29. Lock according to claim 28, wherein said pushing-portion and/or said follower-portion comprise a tilted surface arranged transversely to said entrance direction and to said opening direction.

30. Lock according to claim 27, wherein said motion transferring arrangement further comprises a rotatable lever member provided with appendages suitable for engaging respectively said pushing-portion and said follower-portion, said lever member being rotatable around an axis orthogonal to the plane defined by said opening directions and entrance direction to transfer a movement of said cursor element along said opening direction to said latch along said entrance direction.

31. Lock according to claim 26, wherein said bolt is provided with a driving groove and said protrusion element comprises a pin protrusion protruding from said cursor element to engage in said groove, said groove having a tilted portion in such a manner that a movement of said cursor element in said locking direction causes a projection of said bolt to the outside by a length, and vice versa, a movement of said cursor element in said opening direction is correspondingly followed by a retracting movement of said bolt to the inside of said box body.

32. Lock according to claim 31, wherein said groove comprises a locking portion, extending orthogonally to the movement direction of said bolt, said pin protrusion, in the position of engagement with said locking portion, acting as a locking arrangement for blocking said bolt in said operative position, preventing forced movements thereof from the outside.

33. Lock according to claim 26, wherein said abutting zone of said cursor element comprises:
a first abutting portion that is suitable for receiving from said key-locking-member a pushing action to move said cursor element in said locking direction, and,
a second abutting portion that is suitable for receiving from said key-locking-member a further pushing action to move said cursor element in said opening direction.

34. Lock according to claim 31, wherein said bolt comprises an extracting abutment shaped for coming into contact with, and receiving a pushing action from, said key-locking-member, to make said bolt exit from said box body by a first amount, said bolt being subsequently pushed outside by a second amount from said pin protrusion through the effect of the movement of said cursor element along said locking direction.

35. Lock according to claim 22, wherein said bolt comprises a return-abutment shaped for coming into contact with, and receiving a pushing action from said key-locking-member, to return said bolt inside said box body.

36. Lock according to claim 26, wherein said bolt is provided with:
a first extracting abutment, shaped for receiving from said key-locking-member, at a first rotation of said member, a first pushing action causing the exit of said bolt from said box body by a first amount,
a second extracting abutment, shaped for receiving from said key-locking-member, at a second rotation of said member, a second pushing action causing the exit of said bolt from said box body by a second amount.

37. Lock according to claim 26, wherein said bolt comprises:
a first return abutment, shaped for receiving from said key-locking-member a first push for retracting said bolt by a first amount inside said box body,
a second return abutment shaped for receiving from said key-locking-member a second push for retracting said bolt by a second amount inside said box body.

38. Lock according to claim 26, wherein said abutting zone of said cursor element comprises an abutting portion that is suitable for receiving from said key-locking-member a pushing action to move said cursor element in said locking direction, and in which said protrusion element comprise a follower tilted surface shaped for slidingly engaging with a mover tilted surface provided on said bolt, said mover and follower tilted surfaces being shaped so as to impose on said cursor element a movement in said opening direction at a return movement of said bolt to the inside of said box body.

39. Lock according to claim 36, further comprising a further locking arrangement shaped for locking said bolt in said operative position, preventing forced movement thereof from the outside to the inside of said containing box body wherein said further locking arrangement comprises a pawl member configured for locking said bolt preventing forced movements thereof from the outside, said pawl member being drivable by said key-locking-member to move from a locking configuration—in which any movement of said bolt is blocked—to a release configuration that permits the exit or entrance translation of said bolt.

40. Lock according to claim 39, wherein on said bolt a locking groove is obtained having a toothed profile with recess zones, shaped for coupling with a tooth of said pawl member.

41. Lock according to claim 24, wherein said latch is of magnetic type and is freely arranged in said retracted position when said door is open, said protruding wall being positioned to hinder said locking ridge to prevent the movement of said driving device in said locking direction, said protruding wall enabling said driving device to move in said locking direction when said magnetic latch, in said extracted position, is received in a respective cavity of a door jamb.

42. Lock according to claim 22, wherein said key-locking member comprises a bit element included in a lock cylinder controllable by a key, or comprises a key element provided with a cam portion shaped to act on said driving device and on said bolt.
